(19) United States
(12) Patent Application Publication
(10) Pub. No.: US 2007/0011237 A1
(43) Pub. Date: Jan. 11, 2007

(54) Interactive, rich-media, delivery over IP network using synchronized unicast and multicast

(76) Inventor: Gregory P. Mockett, Spanish Fork, UT (US)

Correspondence Address: PATE PIERCE & BAIRD, 215 SOUTH STATE STREET, SUITE 550, PARKSIDE TOWER, SALT LAKE CITY, UT, 84111, US

(21) Appl. No.: 11/432,776

(22) Filed: May 11, 2006

Related U.S. Application Data
(60) Provisional application No. 60/680,344, filed on May 11, 2005.

(51) Int. Cl. G06F 15/16

(52) U.S. Cl. 709/204

(57) ABSTRACT

A system provides coordinated, simultaneous unicast (e.g. for control and instructions) and multicast (e.g. streamed content) exchange of information to control and deliver media content such as movies, video games, sports, and the like. An interaction layer or client-side application may be employed to identify user interaction, which may, in turn, dictate what multicast streams are tapped or what unicast stream or streams will be sent to effect a desired change in the rich media for movie or video entertainment, gaming, and the like. Unicast streams may be used in place of a multicast stream, relying on the uniqueness of sending distinct streams to a client application for synchronous, concurrent playback, providing advantages in file transfer, streaming speed, error correction, and presentation quality. Any rich media, individually or collectively may have separate “tracks,” to be sent separately from a server and synchronized on the client side.

### RELATED APPLICATIONS

This application claims the benefits of U.S. Provisional Patent Application Ser. No. 60/680,344, filed May 11, 2005, and entitled “INTERACTIVE RICH MEDIA DELIVERY OVER IP NETWORK USING SYNCHRONIZED UNICAST AND MULTICAST,”

### BACKGROUND

1. The Field of the Invention

This invention relates to delivery of rich media and, more particularly, to novel systems and methods for interactive rich media delivery over an IP network.

2. The Background Art

When delivering “rich media” (e.g. audio, video, and the like) over an IP network, several challenges are encountered. For example, cost of bandwidth is too high for publishers of on-demand or streaming video, as all video streams must be provided in a 1:1 ratio with the viewers. Accordingly, if it costs $4 for each concurrent stream, an audience of 1,000,000 concurrent viewers requires $4,000,000. A web site serving pages to the same number of concurrent users may cost $4,000. Additionally, standard definition television delivered over the web at full screen size may incur costs as high as $135 per concurrent stream, or $135,000,000. This forces a compromise that leads to two inch by three inch play windows, poor audio synchronization, low frame rates, low resolution, limited selection, truncation, and other cost-cutting measures.

Multicast technologies could solve the efficiency problem by changing the bandwidth cost to a ratio of 1:∞ (one to infinity), which would not only make it cheaper but would actually make the bandwidth costs become increasingly incrementally insignificant. This would allow the publisher or distributor of video properties to send out “heavier” streams that are capable of full screen, high resolution, full frame rate, etc., quality audio/video properties. However, multicasting technologies severely limit or eliminate interactivity, identity, on-demand, and player-control capabilities.

Multicasting requires a routed path where the routers understand the multicasting IP protocols, relatively few such routers exist, though almost all could be upgraded with suitable software or configurations. However, as may be appreciated, there is a disincentive for the broadband market (largely controlled by large cable distributors) to provide this simple upgrade to routers in the home.

Other challenges in providing rich media over an IP network are caused by the multiple, competing, incompatible players used in the industry to deliver the media. These players are often competing within the client machine, battling over file type display control. This is exacerbated by varying operating systems, browsers, processors, form-factors hardware (e.g. handheld, PC, laptop, TV, phone, etc.), and bandwidth delivery (e.g. set-top systems).

Additionally, Digital Rights Management (DRM) technologies placed in video properties to prevent piracy add to the bandwidth requirement and inflame the “player wars.” While this problem may not be resolved in the near term, a solution needs to be found that is an overwhelming market favorite, such that publishers can save money by formatting for that dominant player and thereby deliver any content, at any time, to any location, on any device.

Another challenge is that access to content is scattered and poorly organized. Current search-engine and directory structures are highly unlikely to index this exploding population of properties because machine-image and video recognition needed for this task are virtually non-existent. While the human mind is easily capable of categorizing this content accurately and quickly, it requires a concentrated effort to educate reviewers and tabulate and organize their summary reviews. No present system aggregates viewers into a single portal for such a practice.

A further challenge is that current browsers were not written to handle rich media. They were written to read and display markup text files. Accordingly, their ability to display other properties including rich media is a function of Plug-ins that attempt to take over that function for the browser. This reader/display motif does not allow the rich media (audio, video, executables for games, and the like) to determine web location(s) and provide the desired interactivity.

While it may be desirable to include web properties (and other types of display/interactivity) directly within the rich media properties, this capability is currently not available. Currently, due to the plug-in/patch browser scenario, selecting a web property in a display window where rich media is playing will typically kill the display in favor of a new web display.

Furthermore, because value-added interactivity such as message boards, chat rooms, etc. programs are, like rich media, page dependent, site dependent, or both, for their continuity, they isolate the web's social qualities to that host site. If a group of friends located remotely from one another decides to watch a movie together, go shopping online together, or read various sports sites together, or game together, they will be sorely disappointed. Due to the manner in which rich media is currently streamed on demand, there is virtually no way to effectively synchronize the display of a rich media property within the same site for multiple viewers.

### BRIEF SUMMARY OF THE INVENTION

In view of the foregoing, and in accordance with the invention as embodied and broadly described herein, methods and apparatus are disclosed in certain embodiments of systems to solve the “low-bandwidth cost or interactivity” dilemma facing web rich media publishers. In selected embodiments, apparatus and methods in accordance with the invention may include a system that streams high-bandwidth, rich-media content downloaded by multicast with intermittent or otherwise low-bandwidth unicast uplinking of user inputs, selections, commands, or the like to a source. The two signals may be synchronized or otherwise bound at an appropriate location, in a way that allows the source to identify the material, location, and command needed, and respond thereto.

A system in accordance with the present invention may send out separate, synchronized unicast and multicast streams. The streams may be combined by a client application such that the unicast stream provides a transparent, interactive layer overlaying the multicast rich media stream. The interactive layer may comprise a “low overhead” video element or a series of static images or image maps relating to the non-static or video content of the rich media. In some embodiments, a third-party authoring system may create interactive, transparent, animation layers or video layers (e.g. Flash layers).

In selected embodiments, multiple multicast streams may be synchronizing on the client side with or without input from a synchronized unicast layer or client side application. Advantages for such delivery may be at least twofold. First, for animation, gaming, or personalizable video content, the publisher may send multiple multicast streams at various start times. A client application may then assemble the streams into a whole, switching the various parts as dictated by the user interaction. This allows for a seemingly unique and dynamic video, gaming, or animation presentation as well as a massive, yet efficient, internet-based, multi-player video-game. Second, “component video” may be sent in multiple, multicast streams that are synchronized on the client side. This may allow high quality video data (i.e. DVD/HD quality) to move over an expanded network to multiple display terminals.

In certain embodiments, an interaction layer or client-side application may be employed to identify user interaction. The user interaction may, in turn, dictate what multicast streams are tapped or what unicast stream or streams will be sent to effect a desired change in the rich media. For example, in some embodiments, user interaction may dictate a preferred camera angle in an internet broadcast. In other embodiments, user interaction may allow a video-game to operate efficiently on a large network. In still other embodiments, user interaction may allow an original animation or movie to be unique to a particular viewer or group of viewers.

In selected embodiments, unicast streams may be used in place of a multicast stream, relying on the uniqueness of sending distinct streams to the client application for synchronous, concurrent playback. This practice may provide advantages in file transfer, streaming speed, error correction, and presentation quality. A similar practice may be applied to any rich media, individually or collectively. Thereby, allowing component video and component audio, like separate audio “tracks,” to be sent separately and synchronized on the client side.

Casting of rich media may be synchronized at the local machine for a coordinated and harmonious presentation. Additionally, synchronization may be coordinated and harmonious with a group of disparate clients viewing terminals having “n” number of such terminals on “n” number of disparate end networks. This may be necessary where rich media is applied to something such as an online dating experience where two individuals in remote places interact in a voice or video chat environment while enjoying a rich media presentation. With current systems, it is impossible to guarantee that these two parties are observing the same content at the same time.

In selected embodiments, rich media streams may be synchronized concurrently, in parallel, some combination thereof, or simply sent to the client-side workstation in separate downloads that may be used concurrently and synchronously by the client application.

In certain embodiments, a system in accordance with the invention may provide error correction across multiple concurrent streams, rather than interlacing within the same stream. This concept is not unlike a striped, RAID array where each stream would be analogous to a separate drive or other storage medium. Using three or more concurrent streams, any stream may disconnect or drop data, and the client application may use data from the other streams to reconstruct the missing data.

If desired, all streams may be synchronized at the server side by one or more coordinating servers. Accordingly, the player or client application may receive a map or table before, or concurrently with, the streams for playback coordination.

In selected embodiments, packets may be encoded with synchronizing data for concurrent synchronous playback by a player. The player may match the streams by the given sequential encoding (whether alphabetical, numeric, ascending, descending, etc.) and buffer until the streams may be aligned.

In certain embodiments, systems in accordance with the present invention may segment a media file by component as defined above and then systematically divide these component subfiles into even smaller increments for faster travel over the network (whether unicast or multicast).

If desired, one or more streams may be scrambled to provide pay-per-view functionality and parental controls. In such embodiments, a key may be added by the user to unscramble the packet and restore proper sequencing. In some embodiments, one or more of the subcomponents may flow through, without the key, such that the picture is without contrast or without blue and green, etc., to motivate a pay-per-view purchase. In still other embodiments, sequencing may be scrambled in varying degrees of distortion. Generally speaking, interferences as described hereinabove may be controlled by a user interface on the client application (i.e. for parental controls), a server based on Cookie or Login processes, or some combination thereof.

In selected embodiments, streams may be scrambled in any number of ways. Such streams may be decoded on the client-side application or workstation. If desired, decoding may be dynamically controlled by the server. That is, the scrambling may change the key from time to time within the same presentation. Such functionality may protect subscription content from capture or viewing by non-subscribers or unauthorized players.

In certain embodiments, user interaction with the player or the synchronous transparent layer may be assessed to determine what point in the synchronous play the rich media is paused, stopped, rewound, switched to a different stream, etc.

If desired, a centralized server may be used to coordinate the use of various streams made available to client applications, whether individually or in combination with other players on disparate terminals in disparate end networks. This may facilitate playback of individual and multiple players for diverse purposes including web theatre, group shopping, true live event management, etc. It may also emulate DVR functionality (e.g. stop, start, pause, skip back, skip forward, etc.), including scene selection, through a web page delivered to the client application or within the transparent layer. Such a web page may preselect various streams that may be switched to either backward or forward, and manage the switching of streams for other purposes such as a change in camera angle, change in “channel,” etc.

### BRIEF DESCRIPTION OF THE DRAWINGS

The foregoing features of the present invention will become more fully apparent from the following description, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a diagram illustrating unicast, bi-directional communication;

FIG. 2 is a diagram illustrating multicast, uni-directional communication;

FIG. 3 is a diagram illustrating a system for interactive, rich-media delivery over an IP network using synchronized multicast and unicast communication in accordance with the present invention; and

FIG. 4 is a table comparing the functionality of unicast communication, multicast communication, and synchronized communication in accordance with the present invention.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of the invention. The presently preferred embodiments of the invention will be best understood by reference to the drawings.

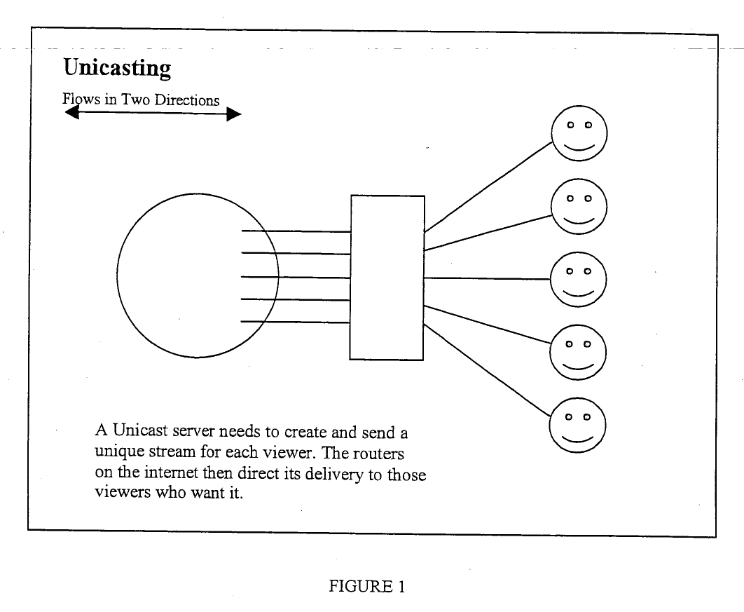

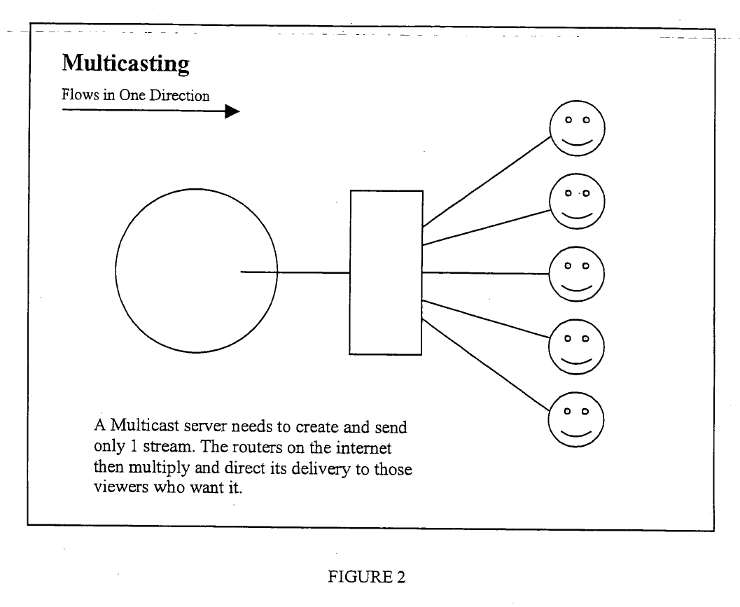

Referring to FIGS. 1 and 2, in the past, there are two webcasting strategies, namely unicasting and multicasting. When unicasting, each stream, including CPU and storage, may typically cost about five dollars ($5). In the example illustrated in FIG. 1, unicasting will cost the content publisher or distributor $25 to reach all users. Accordingly, the cost per viewer ratio is one to one. Each new viewer reached by the publisher will cost the publisher the same incremental increase. Thus, for example, to reach one million users at five dollars per customer, the publisher may have to expend five million dollars ($5,000,000).

When multicasting, a single stream, including CPU and storage, may cost five dollars ($5). Accordingly, in the illustrated example, multicasting will cost the publisher or distributor five dollars ($5) to reach all users. Thus, to reach one million users, the publisher may still only be required to expend five dollars ($5) for that one multicast. Fixed costs are not accommodated in this example.

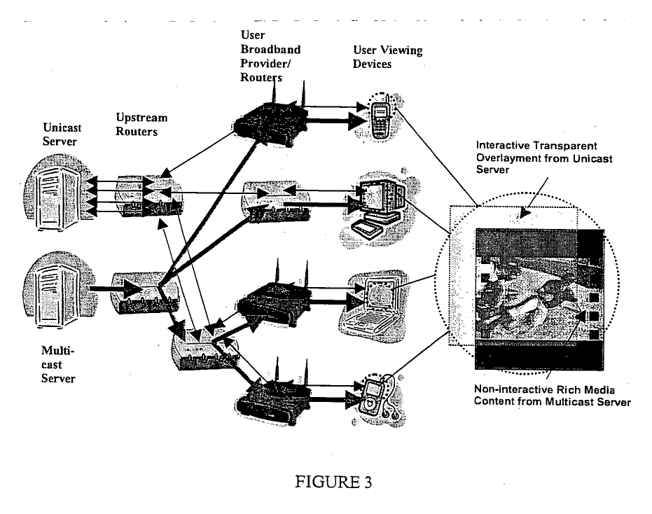

Referring to FIG. 3, use of the systems and methods in accordance with the present invention allows the publisher to simultaneously multicast and unicast (status quo on demand delivery). The bulk of the rich media is multicast on a schedule to a client application that receives and displays the same. The unicast portion may be reduced to a transparent interactive overlay delivered on demand, but synchronized by a communication between the client player and the publisher server or servers. Buffering at the client application may be incorporated as necessary.

To explain this concept, consider a common touch-screen, hardware, display monitor where the monitor is the multicast layer. The thin, transparent interactive film on the touch screen display is the unicast or status quo web layer. This allows the vast majority (up to 99%) of the publisher's bandwidth requirement to deliver at increasingly incrementally insignificant costs while the unicast layer (e.g. typically as little as 1%) of the combined display remains at the one-to-one ratio. This unicast layer identifies the client, provides interactivity, and enables user control of the rich media, and may provide other functionality. In selected embodiments, the overlay is embodied in a separate stream from the rich media sent from the server.

Multicasting, like television, is a one-way stream delivered on schedule rather than on demand. A system in accordance with the present invention may use multicasting to provide on demand control functionality like that provided by a DVR (digital video recorder) or PVR (Personal Video Recorder). These technologies may be combined with other features herein described as part of the whole solution. In certain embodiments, a system may use Hyper Frequent Broadcasting.

For example, one or more servers may send out separate, unique streams of the same rich media property (e.g. a movie) such that if the user selects “pause,” the client application senses the user's request, marks the location (e.g. frame reference from the multicast stream) and asks the server to stand by for further user instruction to resume on a different stream of the same content that happens to be most closely approaching that frame reference. In selected embodiments, multicasts of the same content may be scheduled at irregular intervals, load-based intervals, or regular intervals.

The client and server components of the invention may also employ a changeable random hash or some other encryption scheme that need not be math-intensive, but very dynamic (even intrastream), such that the stream is reasonably protected from piracy. Furthermore, the invention may contain features that analyze the use of key operating system level components. These can be used for screen capture and such. They may be disabled or the programs desiring access to them disallowed when a rich media property is being played. If included, DVR functions may allow for the encrypted data to be stored in multiple files in separate directories making the playback difficult to accumulate, appropriately combine, and redistribute. As a further deterrent, access to on-demand, rich media may be reduced in price such that there is no effective profit in piracy.

To facilitate the receipt and routing of multicasting streams over a non-multicast network, the client application, or a web based applet, where possible, may act as a tunneling agent. As such, it may convert the client machine into a router that can communicate directly with another multicasting router on the web. That other may, in turn, communicate with the publisher's one or more servers. This agent may facilitate the routing and receipt of multiple protocols to maximize the utility of the application and facilitate the purposes of the present invention.

In certain embodiments, the invention may include a client application serving as a browser, a client application accessing the browser as a sub-display of the client, a VirtualBrowser that is a web application simulating a browser within a browser, or some combination thereof. This part of the client side utilities may allow the aggregation of both content (standard web and rich media alike) and the congregation of users of that content via a proxy server (for the unicast layer only).

Thus, the client end of any activity may be synchronized with the proxy/server as well as with the other disparate clients facilitating a “web theater” where the clients are all seeing the exact same content at the exact same time. These clients may not be required to stay in the site produced by the target content server, as they are still coming from the proxy content re-transmitter. Because of this aggregation and congregation, the invention facilitates the leveraging of “human review” of non-machine-discernable content for key information about the contents. This stands opposed to the capture of title and surrounding descriptive information now captured by search and directory engines created to organize these properties online. The system may also facilitate machine management of the reviews.

These reviews may contain not only factual information on actors or actresses, plot, story, genre, etc., but may also contain “ratings” information. This rating information may be plotted as factual data such that various, individual administrators may determine collectively that the occurrence of certain video elements or events are not appropriate thus eliminating the need for ratings such as PG-13, R, NC-17, and the like. This may not only allow corporate network administrators to allow rich media within their networks, but will also facilitate universal filtering, where differing cultural, religious and ethnic values can be profiled and easily engaged by profiled users.

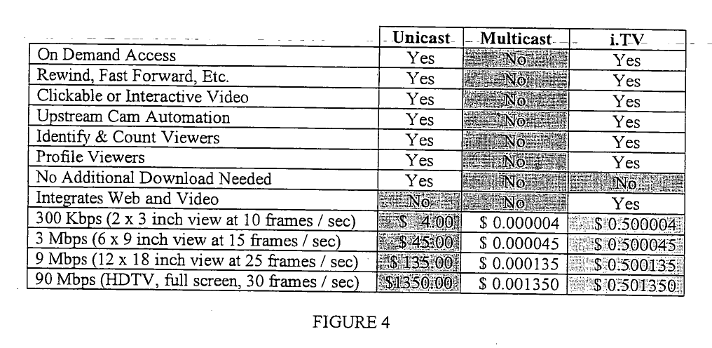

Referring to FIG. 4, the illustrated table provides a comparison of unicast, multicast, and systems in accordance with the present invention (i.e. “i.TV”). All cost comparisons are estimates based on 1,000,000 streams. A unicast stream may serve only one person at a given moment in time, but over an extended period of time, that stream may be used by multiple individuals, typically at a ratio of between 1:7 and 1:20, depending on the popularity of the content being streamed and the access window provided by the publisher. This provides a much more reasonable cost per viewer than simply looking at the stream count or cost. However, such would represent an unreal comparison, since multicasting and “iTV” technologies are unlimited as far as viewers. Therefore, to compare more simply, clearly and accurately, this chart considers one stream per user for unicasting.

The last two stream flows, 9 Mbps and 90 Mbps, are future-looking. Presently, the best downstream bandwidth is within the cable broadband providers and ranges between 3 and 6 Mbps for up to 27 million households. Services such as “4 G” wireless telephone services in Europe, Japan and North America are currently capable of delivering 10 Mbps (HDTV quality on Phones and PDAs). Fiber-to-the-home projects being built out by telecommunications companies and municipalities will probably eventually exceed 90 Mbps downstream and should be available within 5 to 7 years. The basic IP protocols and transport formats may be universal across all delivery platforms in the foreseeable future.

Features, structures, and functions of various embodiments of apparatus, systems, and methods in accordance with the invention may include one or more of the following:

1. A combined solution involving both multicasting and unicasting in a synchronized fashion to create scheduled delivery of interactive, rich media comprising at least one of audio, video, and AV;

2. A client-server schema that synchronizes multicasting and unincasting layers at the client, server, or some combination thereof,

3. A client application or virtual application layer that combines with the process of Hyper Frequent Broadcasting to simulate standard, on-demand, rich-media controls, such as, but not limited to, stop, play, pause, advance frame, back frame, etc;

4. A tunneling application in the client, when combined with a multicasting and unicasting schema and the required sub components, whether of software or hardware, with or without the addition of the capture, mapping and specifying route within network topographies as related to the two layers;

5. A client application to communicate with the server(s) via a unicasting layer to determine the multicasting layer, whether for DVR functionality or for determining stream type for delivery across the multicasting layer, especially where this latter feature allows the client application to request streams relevant to the applicable hardware form factor, without user or publisher interference or interaction;

6. The ability to facilitate automated advertising insertion and tracking within a combined multicasting and unicasting schema where parts of the advertisement placement are split into these natural parts and rejoined on the client side, while the resulting tracking and other advertising functions are conducted via the server side;

7. The ability to create an accurate and exhaustive search and directory tool for rich media online, since multiple people can be aggregated for the review process and the length of play and interactivity can be determined by the combined multicasting and unicasting schema, and where the server can accumulate, tabulate and otherwise organize this data;

8. The function, generally, of bypassing the storage of rich media on the client side, in separately encrypted chunks that are understood solely by an encrypted communication between the client and server(s), so that only this player can find and replay them. Some optional features include: multiple low-math requirement hashes or encryptions employed within the streaming of a single rich-media property, the ability for the client application to move and rename files dynamically on the client hard drive or to delete them automatically when the player is turned off;

9. The family-safe practice of allowing the client, if activated by the administrating adult, to turn on “filters” that prevent all or specific viewers from accessing content online, whether rich media or otherwise, via the client, including the possible disabling of other players that might facilitate multicast/unicast functionality outside of patentable areas and where such would facilitate the delivery of inappropriate content;

10. The use of a profiling engine within the unicast layer as relevant to the multicast layer and the use of that profiling engine to recommend additional content then playing, to insert more appropriate advertising, etc;

11. The optional playing of advertising media either all or in part within the unicast layer within a combined multicasting and unicasting schema to allow for advertisement insertion, offers, etc. unique to each viewer or to groups of users based on profile data captured within that unicast layer or voluntarily provided by the demographic;

12. The ability to generate a “web theater” and other social or multi-client applications in a combined, multicasting and unicasting schema, where these layers work together to facilitate synchronization for a subset or closed group of clients on an open subset of content;

13. The ability to offer multiple divergent streams of sub content placed in the user's control where such involves the combined multicasting and unicasting schema. Thus, a sporting event might, for example, involve multiple camera angles or separate language audio tracks being sent to the user who can then switch back and forth at his or her sole whim or watch the “director's cut” version; or

14. Any combination of one or more of the foregoing features.

The present invention may be embodied in other specific forms without departing from its spirit or essential characteristics. The described embodiments are to be considered in all respects only as illustrative, and not restrictive. All changes which come within the meaning and range of equivalency of the claims supported by the embodiments illustrated, described, or otherwise disclosed are to be embraced within their scope.

Wherefore, I claim:

1. An apparatus comprising a computer readable medium containing operational and executable data structures to program at least one processor, the executables comprising:
a multicasting module;
a unicasting module;
the unicasting and multicasting modules configured to synchroniz to create scheduled delivery of interactive, rich media comprising at least one of audio, video, and AV.

2. The apparatus of claim 1, further comprising:
a client module;
a server module; and
the client and server modules programmed with a client-server schema that synchronizes multicasting and unincasting layers of at least one of the client module, server module, and a combination thereof.

3. The apparatus of claim 2, wherein the client module hosts a virtual application layer that combines with a process of Hyper Frequent Broadcasting to simulate standard, on-demand, rich-media controls comprising at least one command selected from stop, play, pause, advance frame, and back frame.

4. The apparatus of claim 2, wherein the client module further comprises a tunneling module operable with the multicasting and unicasting schema in a mode with capture and a mode without capture, mapping and specifying a route within network topographies related to two layers.

5. The apparatus of claim 2, wherein the client module is programmed to communicate with the server module via a unicasting layer to determine a multicasting layer to determine delivery of content across the multicasting layer.

6. The apparatus of claim 5, further comprising an advertising module to provide automated advertising insertion and tracking within a combined multicasting and unicasting schema where parts of the advertisement placement are split to be rejoined by the client module, while the tracking and other advertising functions are conducted by the server side module.

7. The apparatus of claim 2, wherein the executables further comprise a search module to create a directory tool for rich media online to serve an aggregation of users operably connected to the server, and the server is programmed to accumulate, tabulate and organize data of the directory.

8. The apparatus of claim 2, wherein at least one of the the client and server modules is programmed to bypass storage of rich media to limit delivery of content by the nature of the client module.

9. The apparatus of claim 2, wherein the client module contains an administrative module to control filters to limit viewers from accessing content.

10. The apparatus of claim 1, wherein the executables further comprise a profiling engine to recommend additional content.

11. The apparatus of claim 10, wherein the profiling engine is further programmed to control advertisement insertion corresponding uniquely to a user of the client module, based on profile data captured by the profiling engine.

12. The apparatus of claim 2, wherein the executables further comprise more than one client module and a theater module to generate a applications to be delivered to the more than one client module.

13. The apparatus of claim 2, wherein the executables further comprise a selection module to navigate multiple divergent streams of content to a user corresponding to the client module and to arbitrarily switch back and forth at the discretion of a user between the divergent streams.
